(19) United States
(12) Patent Application Publication
(10) Pub. No.: US 2011/0098614 A1
(43) Pub. Date: Apr. 28, 2011

(54) METHOD FOR TREATING, PREVENTING OR AMELIORATING DVT

(76) Inventor: Noel Robertson McKenzie, Worthing (GB)

(21) Appl. No.: 12/962,073

(22) Filed: Dec. 7, 2010

Related U.S. Application Data
(62) Division of application No. 10/494,118, filed on Oct. 25, 2004.

(30) Foreign Application Priority Data
Oct. 31, 2001 (GB) 0126063.7

(51) Int. Cl. A61H 7/00

(52) U.S. Cl. 601/136

(57) ABSTRACT

In order to provide an exercise device to give movement of the calf muscles to help pump blood from the legs to the heart and thereby reduce the risk of DVT, an oval or elliptical shaped oscillator is provided which can be used by a seated person by rocking the device backwards and forward underneath the foot. Lift is provided by the dual can effect of the rocking device, reacting with the floor, which increases the angle of the foot so as to flex the calf muscles.

This invention relates to devices for exercising the human body, and the legs in particular.

Recently, it has become more widely understood that seated and inactive persons, such as aircraft passengers, may be prone to deep-vein thrombosis (DVT), occurring in the main over longer journey times and affecting the legs in particular. Normally, movement of the calf muscles helps to pump blood from the legs to the heart. However, if the legs are rested or inactive for extended periods, such as in the case of long haul air travel, there is a risk of blood clots forming in the legs, although these may be dispersed through exercise that activate the calf muscles to increase the flow of blood. Whilst seated, this can be best achieved by rocking the foot at the ankle which, primarily, generates movement in the calf muscle group.

Certain exercise devices for the legs are produced that may be operated whilst seated for the relief of DVT. However, these devices need setting up and may not always fully exercise the calf muscles due to imprecise action through not being, operated correctly. The present invention sets out to provide improvements in these respects.

The present inventor has realised that a simple and highly effective exercise device may be provided in the form of a rigid body comprising a foot-contacting surface and a floor-contacting surface which are configured so that rolling the floor-contacting surface over a floor surface will cause the foot-contacting surface to rise above the floor surface. Surprisingly, the action of lifting the foot causes the calf muscles to contract in a way which helps to pump blood through the veins in the leg. Repeated operation of the device in a rocking, oscillating or rolling motion causes a repeated contraction and relaxing of the calf muscles and can help resist the formation of clots and deep vein thrombosis.

The present invention accordingly provides an exercise device comprising a solid body having a first surface for contacting the instep of the foot of a user and a second surface for contacting a floor surface wherein the outer profile of the first and second surfaces correspond to a substantially symmetrical ellipse, an asymmetrical ellipse, an ovoid, oblong or round edge polygon, the first and second surfaces being configured so that rolling the second surface over a floor surface causes at least a part of the first surface to rise with respect to the floor surface, wherein a cross section of a foot contacting zone of the device has a greatest dimension and a least dimension, the ratio between the least dimension and the greatest dimension being in the range 1.0:1.05 to 1.0:2.0.

The present invention further provides an oscillating device that functions under the instep that employs an elliptical shape or offset motion, to provide an increase in height or lift for the foot when rocked or rotated in either direction, and wherein a cross section of a foot contacting zone of the device has a greatest dimension and a least dimension) the ratio between the least dimension and the greatest dimension being in the range 1.0:1.05 to 1.0:2.0, 1.0:1.15 to 1.0:2.0.

According to the present invention, an oblong length of material is shaped to act as a support and fulcrum for the foot whilst seated. The oscillator is located under the instep; just forward of the ankle, so that it can be rocked, or oscillated, backwards and forwards by the foot which, primarily, requires the effort of the calf muscles, thus increasing blood flow in the leg concerned.

Preferably, the second surface is a smoothly curving surface or a surface defined by a plurality of small stepped surface segments whose edges lie on a smooth curve. Suitably, if the surface comprises small surface segments, each surface segment is no wider than 2 cm, preferably no wider than 1.5 cm and preferably no wider than 0.8 cm. Preferably, the first surface is also curved, being defined by a smooth curve or a aeries of stepped surface segments in a similar way to the second curved surface. Suitably, the first and second surfaces define a closed body.

The necessary rising action is achieved because the body is generally non-circular, being elliptical, ovoid, oblong or polygonal with rounded edges.

All of these figures have the advantage that, when they are pushed, pulled, rooked, oscillated or rolled across a floor surface, using the foot, a rising action is generated in the foot, causing the calf muscles to contract.

The first and second curved surfaces may have substantially the same form so that the device can be used with either surface in contact with the floor or with the foot.

The device may comprise a section of a cylinder or prism whose cross section has the shape described above. Alternatively, it may be a section of a conoid, a pair of conoids meeting at their bases, or a cylindroid, having outwardly bowed side walls in a manner of a barrel, or inwardly bowed side walls.

The body may even be in a form of a distorted ball.

The body may be formed of any suitable material, for example, metal, synthetic material such as thermoplastic or composite material, wood, paper, papier maché or any other suitable material. A suitable material is polystyrene. The device may be formed by any suitable technique, such as moulding. It may be formed as a solid body or it may comprise a hollow body.

Where the body is in form of a hollow body, it may be open at least one end, so that items may be stored inside the body. Removable closure means may be provided for at least one end of the body.

The body may be symmetrical about at least one and preferably two planes of symmetry, suitably, the planes of symmetry intersect one another at right angles.

Where the device comprises a symmetrical body, it can be placed any way round or anyway up and will still function.

The shape of the body is further defined by defining the shape of the cross section of a foot-contacting zone of the device. In the foot contacting zone, a crone section, extending between a foot contacting portion and ground contacting portion will have a greatest dimension and a least dimension. For example, if the shape were elliptical, these would be the distance along the minor axis and the distance along the major axis.

Suitably, the greatest dimension is in the range 50-150 mm more preferably 50-100 mm. Preferably, the least dimension is in the range 20-10 mm, more preferably 25-60 mm. The ratio between the lea-et and the greatest dimension is in the range of 1.0:1.05 to 1.0:2.0, preferably 1.0:1.15 to 1.0:2.0 more preferably 1.0:1.2 to 1.0:1.9 most preferably around 1.0:1.5 to 1.0:1.8.

The first and second surfaces may be textured to improve grip. For example, they may be roughened, matt, ridged, stepped or grooved to improve contact and friction.

Where the shape comprises an ellipse or at least approximates to an ellipse, the shape may be defined with reference to a plane dissecting a circular section cylinder at an angle. The angle between the plane and a plane which is perpendicular to the axis of the cylinder is referred to. In this case, the shape of the foot-contacting portion is suitably defined by a 20-60° ellipse or ellipsoid, preferably a 35-40° ellipse or ellipsoid.

If the difference between the greatest and least dimension is not sufficiently large, an insufficient lifting action is obtained. Suitably, a lift in the range 10-25 mm is obtained when rolling the device over a distance of about 5 cm.

If, however, the difference between the greatest dimension and the least dimension is too much, the device becomes difficult to operate. Further, if the difference is too small, the object will tend to approximate too much to a smooth cylinder and may roll around floor in an uncontrolled fashion, providing a hazard to other people.

The body may comprise at least two parts which fit together for use. The parts may define between them a space for enclosing objects. The shape must be constructed in a way, known to the person skilled in the art, so that it can bear the weight of at least the leg of a fully grown adult.

Alternatively, the body may comprise two geometrically similar parts, one of which is slidably mounted in the other, so that the device may be opened like a telescope.

The present invention further provides a method of exercising the foot, comprising placing an exercise device according to the invention between the instep of the foot and a floor surface and rocking, oscillating or rolling the foot and the device backward and forwards.

It is a particular advantage of the present invention that it may be used while the user is in a seated position. For example, it may be used by a passenger in an aircraft or other vehicle whilst at their seat, allowing for use with minimal interference. It employs a natural foot action. The device may be used substantially silently, as it does not require hinges or other moving parts. The device may be prepared for use simply by placing it on the ground, making it easy to operate.

Preferably, the device is formed of material, thickness and size which allow its weight way to be small. Preferably, the weight is in the range 50-250 gms more preferably 100-150 gms.

Optional feature of the invention may include a timer device for setting off a warning, for example a flashing light, buzzer or other device for alerting a user that it is time to exercise.

The lifting motion imparted to the leg may be taken up by movement of the foot or movement of the whole leg, according to the preference of the user.

In either case, the calf muscles will be contracted, with the accompanying beneficial effect.

By way of example, a specific embodiment of the invention, referred to in the description as an oscillator, will now be described with reference to the accompanying drawings in which:—

FIG. 1 shows in perspective, the general configuration of the oscillator.

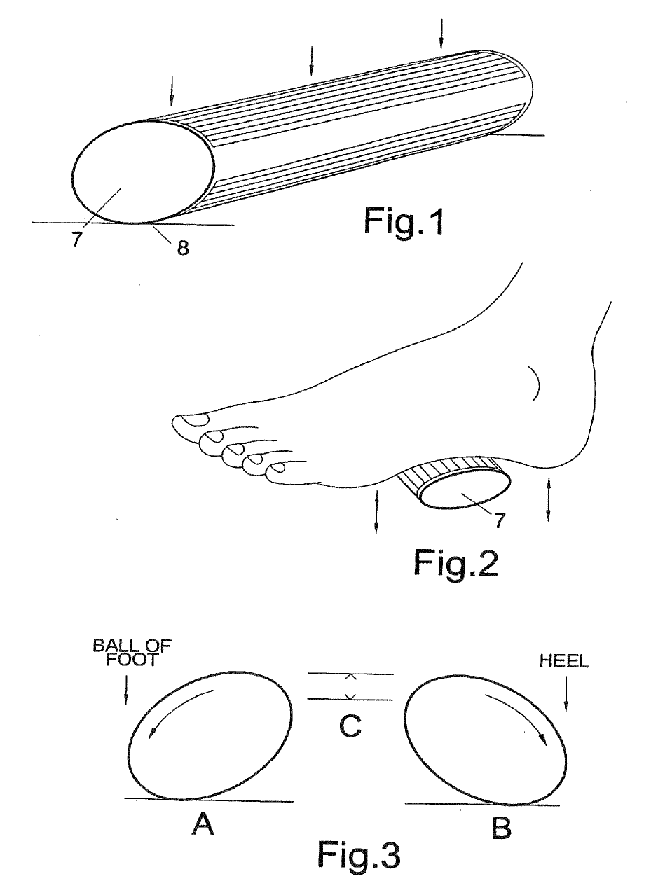

FIG. 2 shows in perspective, the oscillator in position under the in step.

FIG. 3 illustrates in end view, the alternating positions of the oscillator.

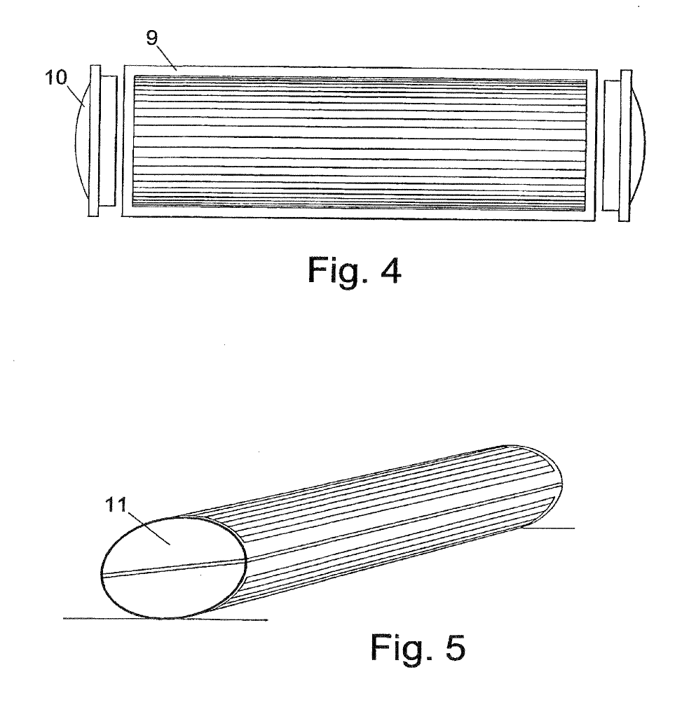

FIG. 4 illustrates the top and underside details of the oscillator.

FIG. 5 shows the oscillator in two parts.

Referring to FIG. 1, an oblong, oval-shaped oscillator 7, which may be of solid or hollow construction, is designed to function under and across the instep of the foot whilst supporting the full weight of the leg and foot on its upper surface, as indicated by the arrows, and with the underside being in contact with the floor at 8. The oscillator and foot may then be rocked backwards and forwards on the spot by applying alternate pressure with the ball of the foot and heel, with shoes on or off. The oscillator 7 is symmetrical in design so that either surface may provide the floor-contacting surface or the foot-contacting surface.

According to FIG. 2, the oscillator 7 is shown in position with the leg near vertical and arrows indicating the rocking motion of the foot.

Referring to FIG. 3, the central principle employed in the oscillator is that the dual cam effect of the rocking ellipsoid, reacting with the floor, lifts either the front or back of the foot as it is progressively rotated so that the following occurs. Diagram A shows the oscillator rocked forwards by pressure on the ball of the foot so that the rear lobe of the ellipse has risen, giving an increase in height shown at C which is lifting the heel and increasing the angle of the foot to the horizontal plane so as to fully flex the calf muscles. Diagram B shows the oscillator rocked backwards by downward pressure of the heel which is lifting the front of the foot and also increasing its angle to the horizontal plane so as to fully flex the calf muscles in reverse. The ‘pumping’ effect of the calf muscles can thus be controlled and varied depending on the degree of effort applied to the rocking action, affecting the angle of the foot.

The oscillator may also have an asymmetrical, or egg-shaped, outer profile which provides a variation in lift characteristics, if required.

According to FIG. 4, the plan view of the upper and lower surfaces of the oscillator shows lateral ridges 9 which improve grip and control slippage at the foot and floor interfaces when in use. If the oscillator is of hollow construction, end cap(s) 10 may be removable to access items that may be kept within.

Referring to FIG. 5, the oscillator may be constructed of two separate halves with the horizontal join surfaces shown at 11. The oscillator may function as a single unit if the halves are joined together, or it may be separated to provide two units that may be used with the flat surfaces uppermost in contact with the feet.

The oscillator 7 shown in FIGS. 1 and 5 of the drawings comprises an elliptical sectioned prism.

When seen in cross section, the width along the major axis is 57 mm and the depth along the minor axis is 33 mm, corresponding to a 36° ellipse.

The prism section is preferably of length of 106 mm. The device is formed of thermoplastic material and weighs 120 gms.

In order to determine the effectiveness of the device according to FIG. 1 for increasing blood flow and for resisting DVT, live tests were carried out at a leading Medical Centre.

Ten healthy subjects of both sexes were individually tested at half hourly intervals to evaluate how using the device of FIG. 1 affected blood flow in the legs. A standard economy class aircraft seat was provided in which each subject remained for the duration of the test. A sensor was attached to each leg to monitor venous outflow Vo in the femoral region. The left leg (LT) was kept static as a control throughout the test while the right (RT) foot and leg were exercised. the object being to determine blood flow differential in the legs as a result of right leg activity alone, thus indicating blood flow improvement directly attributable to the exercise device of FIG. 1.

The subjects were seated and totally inactive for the initial two hours so that the fall off in venous outflow could be monitored in both legs. Thereafter, at half hourly intervals, the right foot were exercised for one minute duration using the device of FIG. 1 and the Vo readings were taken 15 minutes after cessation of exercise. Exercise was conducted every 30 minutes for one minute only.

The following results were obtained.

After two hours, venous outflow from the unexercised left leg was reduced by 43.5%. In contrast, venous outflow in the right leg, 15 minutes after exercise was ceased had only reduced by 19.57%. Further, venous capacitance was measured. The venous capacitance of the left leg after two hours had increased by 34.66% whereas it had only increased by 30.1% in the right leg.

It can be seen that there is 55% improvement in blood flow produced by just one minute of exercise. This value compares directly with blood flow improvements obtained by normal walking action for the same time in a similar test environment.

The present invention has been described above by way of example only. Modification can be made within the spirit of the invention which extends to equivalents of the features described. The invention also consists in any individual features described or implicit herein or shown or implicit in the drawings or any combination of any such features or any generalisation of any such features or combination.

1. A method for treating, preventing or ameliorating in a human patient the effects of the circulatory ailment deep-vein thrombosis associated with prolonged sitting, the method comprising the steps of
(a) providing an exercise device comprising a rigid solid body or a rigid hollow body having a first surface for contacting the instep of the foot of said patient and a second surface for contacting a floor surface, the exercise device characterised in that an outer profile of the device corresponds to a substantially symmetrical ellipse, an asymmetrical ellipse, an ovoid, or an oblong in which the first and second surfaces are curved or a round edged polygon in which the first and second surfaces are curved, the first and second surfaces being configured so that rocking the second surface over a floor surface causes at least a part of the first surface to rise with respect to the floor surface, and
(b) at periodic intervals placing said device between the instep of the foot of said patient and a floor surface, and continuously rocking, oscillating or rolling the foot and the device backward and forwards along said floor surface for at least one minute.

2. A method according to claim 1, wherein a cross section of said exercise device corresponds to a 20° to 60° ellipse or ellipsoid, preferably a 35-40° ellipse or ellipsoid.

3. A method according to claim 1, wherein a cross section of a foot contacting zone of said exercise device has a greatest dimension and a least dimension, the ratio between the least dimension and the greatest dimension is in the range 1.0:1.05 to 1.0:2.0.

4. A method according to claim 3, wherein the ratio between the least dimension and the greatest dimension is in the range 1.0:1.15 to 1.0:2.0.

5. A method according to claim 3, wherein the ratio between the least dimension and the greatest dimension is in the range 1.0:1.2 to 1.0:1.9

6. A method according to claim 3, wherein the ratio between the least dimension and the greatest dimension is in the range 1.0:1.4 to 1.0:1.8.

7. A method according to claim 1, wherein said exercise device comprises two halves which may be releasably fixed together.

8. A method according to claim 1, wherein said exercise device is in the form of a round edged polygon in which the first and second surfaces are curved and the ratio between the least dimension and the greatest dimension is in the range 1:1.15-1.0:2.0.

9. A method according to claim 1, wherein said solid or hollow body corresponds to a substantially symmetrical ellipse, an asymmetrical ellipse or an ovoid, wherein the cross section of the device corresponds to a 20° to 60° ellipse or ellipsoid.

10. A method according to claim 1, said exercise device being hollow and having removable closure means for at least one end of the body.

11. A method according to claim 1, wherein said first and second curved surfaces have substantially the same form so that the device can be used with either surface in contact with the floor or with the foot.

12. A method according to claim 1, wherein said periodic interval comprises about thirty minutes.

13. A method according to claim 1, wherein said first and second surfaces are textured to improve grip.
